(19) United States
(12) Patent Application Publication
(10) Pub. No.: US 2007/0136170 A1
(43) Pub. Date: Jun. 14, 2007

(54) Variable momentum monitoring system

(75) Inventors: Kent Russell Davis, Victoria (AU); Peter John McCoy, Victoria (AU)

Correspondence Address: VOLPE AND KOENIG, P.C., UNITED PLAZA, SUITE 1600, 30 SOUTH 17TH STREET, PHILADELPHIA, PA, 19103, US

(73) Assignee: NGA Software Corporation (International) Limited, Hong Kong (CN)

(21) Appl. No.: 10/579,454

(22) PCT Filed: Aug. 11, 2004
(86) PCT No.: PCT/AU04/01072

§ 371 Date: May 16, 2006

(30) Foreign Application Priority Data
Nov. 17, 2003 (AU) 2003906308
Feb. 10, 2004 (AU) 2004900637

(51) Int. Cl. G06Q 40/00

(52) U.S. Cl. 705/36 R; 340/7.48; 340/825.27; 455/466; 705/35

(57) ABSTRACT

A variable momentum monitoring system including the steps of:receiving from a user an identification of a required variable data input; obtaining the current live static value (LSV) of the identified required data input from a dynamic live data-stream and determining it as a base reference input (RI); calculating at least two sets of one or more incremental reference variable levels (RVLs) using the determined RI, one of the sets having values less than the RI and the other set having values greater than the RI; searching dynamic live data values (LDV) of the identified required data and comparing with the reference variable levels (RVLs); communicating to the user when the current live value of the identified required data matches with any of the reference variable levels (RVLs).

### FIELD OF THE INVENTION

This invention is related to a method and apparatus for determining and communicating changes in a variable. It is particularly related to changes in price of shares, futures or options on a stock exchange such as the Australian Stock Exchange (ASX) and using a telephone network such as Telstra™ (in Australia) to communicate the change by SMS or email, but is not limited to such use.

### BACKGROUND OF THE INVENTION

It is known in the share context that there are many static price based stock management and alert systems which operate by the end-user inputting their particular stock code and specific price alert level (ASX code and price) either via a website or a WAP enabled mobile telephone handset. The system then identifies price matches between the ASX live price of a stock and the inputted stock alert price. Once a price match is identified, a Short Message Service (SMS) alert or email is generated from the system. A new or fresh data input process is then required every time an alert is triggered, making the whole process user unfriendly, labour intensive and not automatic.

There appear to be few, if any, telecommunication-based, automatic 24 hr/7 day stock monitoring systems operating in the world today. However, there are many stock management and alert systems. The most commonly available commercial alert systems in Australia come from Iguana 2™ (SMS Quotes) and Stock Alerts™. There are many other alert systems, all operating with the same static price based format but used specifically for a group's own clients i.e. Commsec™, Westpac™.

One of the problems with these systems is that they are all static price based. This means that a specific price must be entered by the end-user before the system can be activated and further price entries are required following price triggers in order to maintain the system's activity status. In these static priced systems, each time an alert has been triggered it is washed from the system and therefore requires fresh or new data input to maintain active status. As a consequence, these static price based systems require ongoing end-user input. Ultimately, the end-users tire of this ongoing data input process which becomes logistically more difficult the more stocks or variables that are being monitored for specific alert levels.

Additionally, many of the static priced and WAP based systems require access to either a payment gateway or a remote website to register and/or pay. SMS Quotes™ utilises the Telstra™ WAP portal but, initially, the end-user must visit a remote website and pay a monthly fee for the service before it can be accessed and used.

Still further, all of the static price and WAP based stock management and alert systems are really only suitable for well experienced internet end-users who can navigate through the set up and payment process. Static price based applications are not suitable for Telecommunication models. Such models require simple operating formats in respect of use, set up and access; i.e. they must be as simple as the Telstra™ 101™ free answering service that operates throughout Australia. This service requires only three pushes of a key pad (the entry of the number 101) and the system is set up and ready for use.

The major problem with all static price based alert systems is that they require far too much ongoing end-user input. All static price based systems require entry of at least two data elements—stock code and stock price. It is important to understand the static priced based systems and how they work. Such an understanding highlights the clear and unique differences between the static priced based system and the invention.

It is therefore an object of the-invention to provide a variable momentum monitoring system which overcomes or at least amelisrates the problems of the prior art and, preferably, can be automated to the point at which it requires a minimal input from an end-user. In particular, it is an object of the invention to provide a price momentum (or movement) monitoring system; most particularly, a telecommunications based system.

“Variable”, as used herein, includes the price of shares, futures or options on a stock exchange (such as the Australian Stock Exchange), a timetabled event, or the like.

### SUMMARY OF THE INVENTION

In accordance with the invention there is provided a variable momentum monitoring system including the steps of:

receiving from a user an identification of a required variable data input; obtaining the current live static value (LSV) of the identified required data input from a dynamic live data-stream and determining it as a base reference input (RI);

calculating at least two sets of one or more incremental reference variable levels (RVLs) using the determined RI, one of the sets having values less than the RI and the other set having values greater than the RI;

searching dynamic live data values (LDV) of the identified required data and comparing with the reference variable levels (RVLs);

communicating to the user when the current live value of the identified required data matches with any of the reference variable levels (RVLs).

### PREFERRED EMBODIMENTS OF THE INVENTION

Preferably, when a LDV matches a RVL, an advice message is generated and communicated to the user.

In a preferred embodiment of the invention, the system will capture the LSV of a required data input (where LSV=RI) and use it to calculate the RVLs. The RVLs will be calculated as predetermined variations from the captured RI.

It can be seen that the system shows the change over time by communicating different variable matches. Therefore if the variable continues to increase there will have been communicated a first match with a first reference variable level (RVL+1) which could for example be 10% higher and then a second reference variable level (RVL+2) which is for example 20% higher than the reference input. Therefore the momentum of the variable is communicated and not just the match with a predefined number. This momentum can also be communicated in time display format such as graphically or be received and computed by the receiver of the user into a time display format such as graphically based on signals of matches to the reference input (RI) or one or more of the reference variable levels (RVLs).

The identification of the required variable data input by the user may be by digital mobile telephone (utilising WAP and SMS gateway), internet, intranet or general telecommunications network (telephone). Preferably, the communication of any match between the live data values and the calculated RVLs to the end-user is by SMS.

In order to minimise multiple advice messages for the same RVL, (as a result of volatility within a trading period), it is preferable to provide a function that enables only one advice message to be generated in succession for each RVL trigger previously calculated. If an advice message has been generated from the triggering of a specific variable movement (or momentum) level, this same advice message can only be generated again once another variable movement level has first been triggered. This function is called the Alternate Advice Generation (AAG).

The invention also provides for the outer reference variable level points to be defined as reset points such that when the current live value of the identified required data matches with one of the outer reference variable levels (e.g. RVL+4 and RVL −4) apart from communicating the match, the RI is then automatically reset and new reference variable levels (RVLs) are automatically calculated without the need for end-user input. In addition, the RI reset can be executed manually by the end-user at any time without waiting for a match with any outer reference variable level.

The invention also may provide a function that permits the end-user to reset or reprogram the RVLs. This can be executed either from a mobile/PDA handset or website at any time for a variable, such as for all portfolio stocks or for individual stocks.

In a highly preferred embodiment, the system includes the steps of:

receiving from a user an identification of a required variable data input and an identification of a required proportional variation of the variable;

obtaining the current live static value (LSV) of the identified required data input from a live data-stream and determining it as a base reference input (RI);

calculating two sets of one each of incremental reference variable levels (RVLs) using the determined RI and the user's identified required proportional variation, one of the sets having a value proportionally less than the RI and the other set having a value proportionally greater than the RI;

searching dynamic live data values (LDV) of the identified required data and comparing with the RVLs;

communicating to the user when the current live value of the identified required data matches with either of the RVLs; and

resetting the RI to the value of the matched RVL and recalculating the two RVLs using the reset RI and the user's identified required proportional variation.

The proportional variation (which can be referred to as a “tolerance” or “tolerance level”) can be set at any value between 0-999%.

It is important to note that the RI is not the critical data element used in the monitoring loop. The RI is used to calculate the reference variable levels (RVLs). It is the RVLs that are price matched with the dynamic data stream (LDV) and trigger the reset of the RI once the RVLs have been matched (or the outer RVLS in the case of sets of RVLs having more than one member each). Similarly, it is the interaction of the RVLs that generate the advices and enables the system to operate automatically and ongoing with minimal end-user data input other than that of entering/deleting stock codes for monitoring.

Also in accordance with one preferred form of the invention there is provided an automatic telecommunications based price momentum monitoring system which comprises stock exchange (SX) stock code data input by a user via mobile handset or website in which:

an SX code is logged;

a proprietary trading combination (PTC) reader captures the live SX price for the logged SX code as a reference price (RP) and time and date stamps the entry and reconciles customer account details in a telecommunications provider's network;

the PTC reader immediately calculates two sets of price momentum levels (PMLs) using the captured RP of each logged SX code, one set above the RP and the other set below the RP;

the system searches for price matches between SX live feed and PMLs and when a match is detected the system sends a telecommunication to the user; and the RP is automatically reset as the price of a stock moves out of the PML alert range (i.e. beyond either the upper PML or the lower PML) so as to enable the system to be automatic and ongoing. This reset function can be facilitated by the end-user at any time manually.

### DETAILED DESCRIPTION OF THE INVENTION

In order that the invention is more readily understood an embodiment will be described by way of illustration only with reference to the figures wherein:

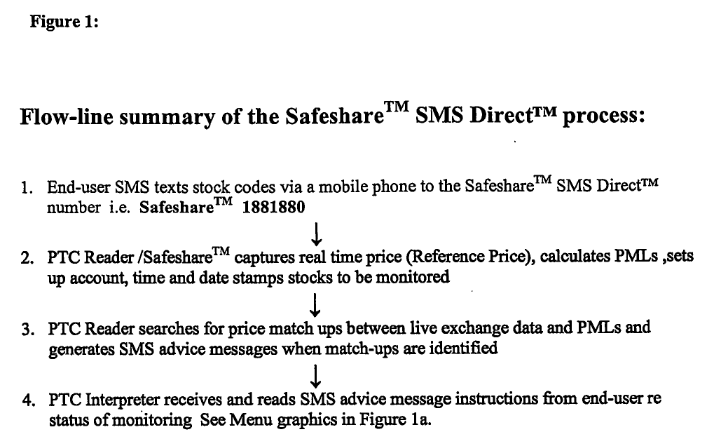

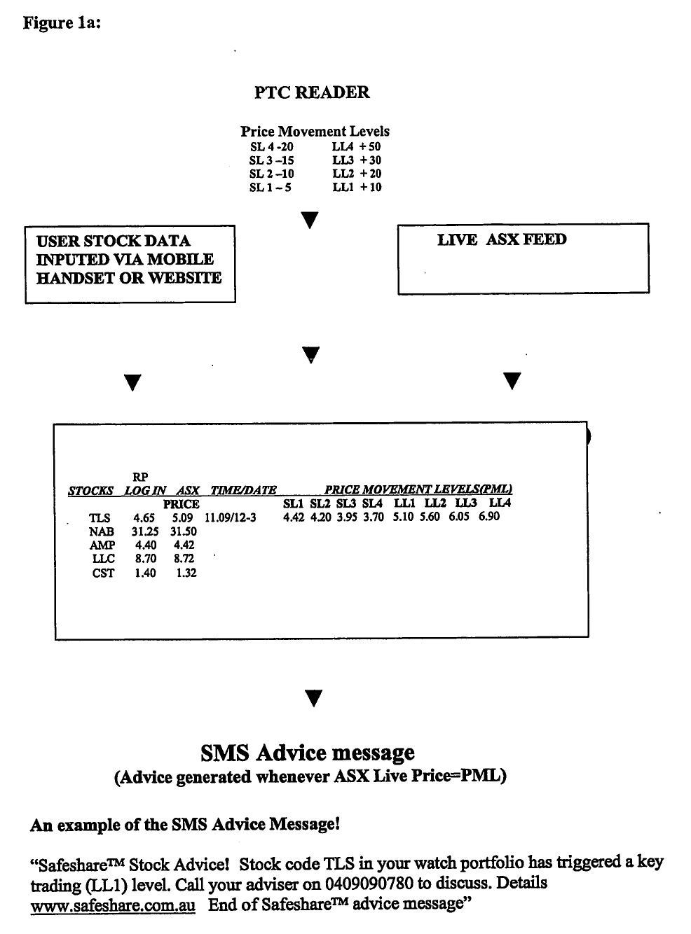

FIGS. 1 and 1a show a summary of a variable momentum monitoring system in accordance with one embodiment of the invention;

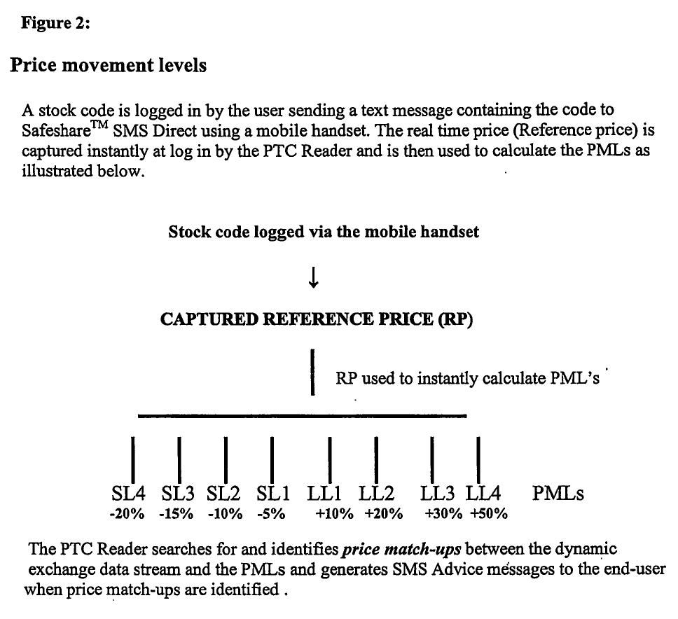

FIG. 2 is an example of suitable preset trading levels in relation to a reference price;

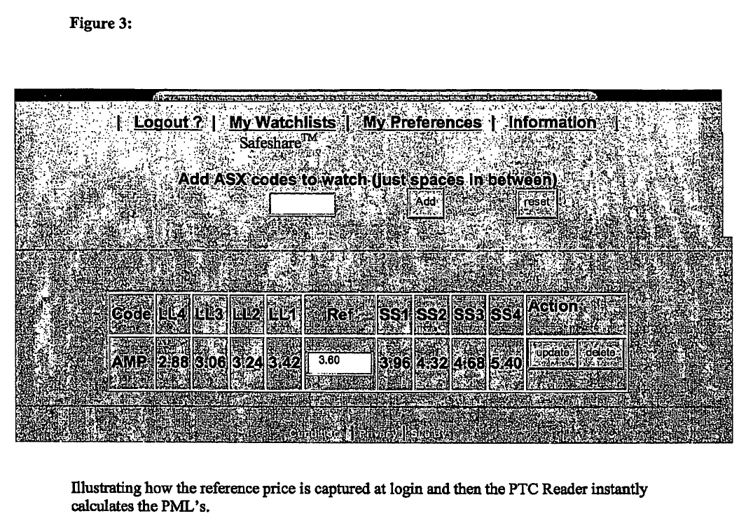

FIG. 3 is a further example of the preset trading levels in relation to the reference price;

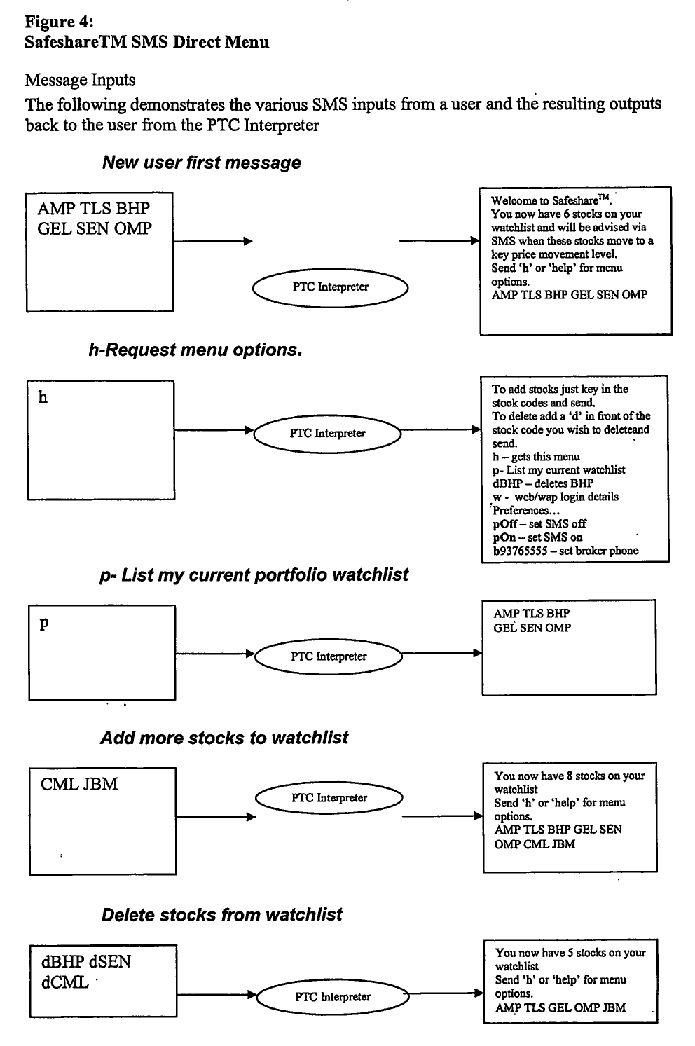

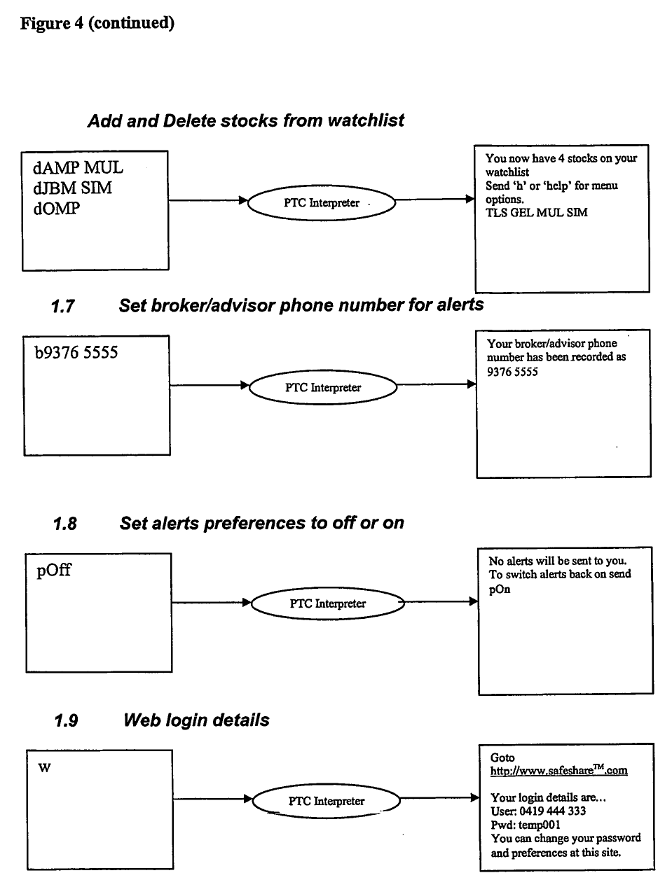

FIG. 4 is an example of a menu for SMS input for an embodiment with fixed trading levels;

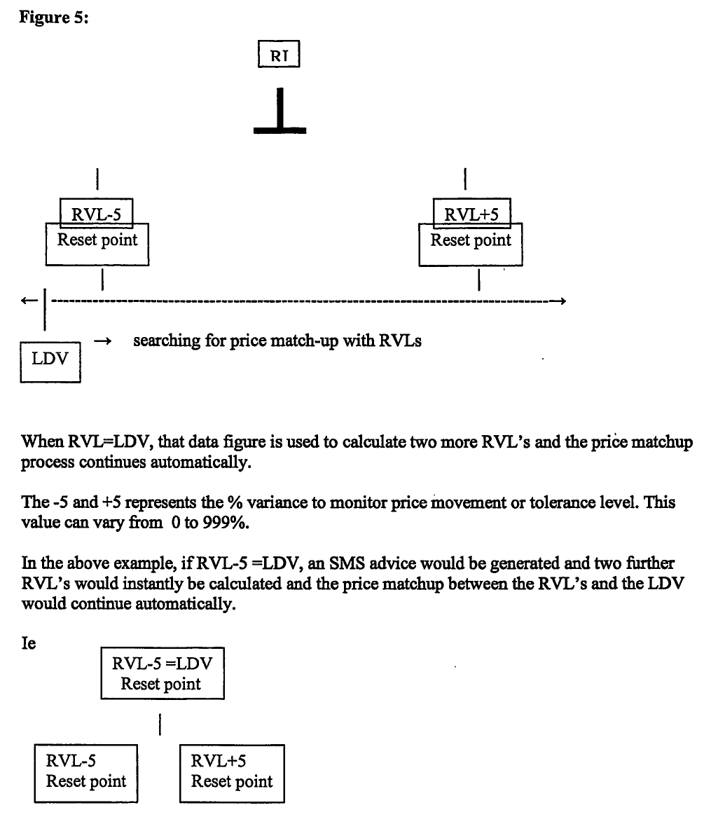

FIG. 5 is a flow chart of an embodiment using a tolerance to set trading levels;

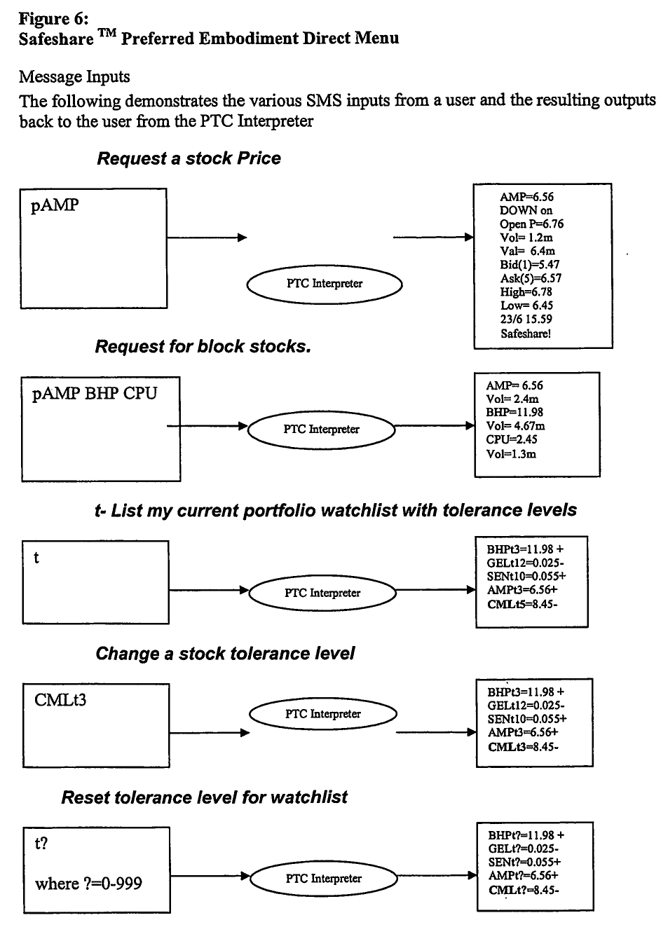

FIG. 6 is an example of a menu for SMS input for the embodiment shown in FIG. 5;

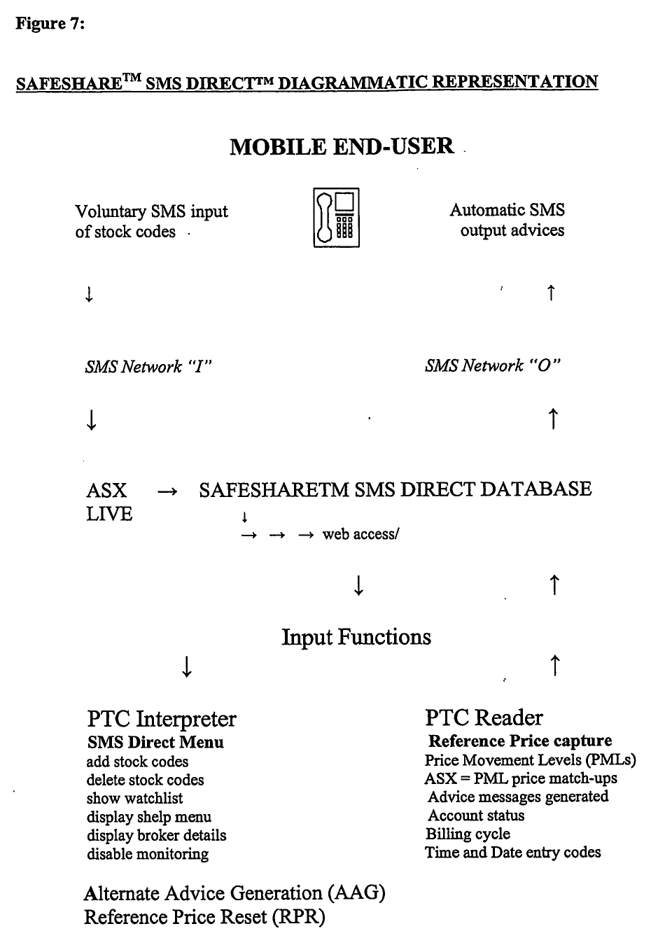

FIG. 7 provides an organisational flow chart of the technology; and

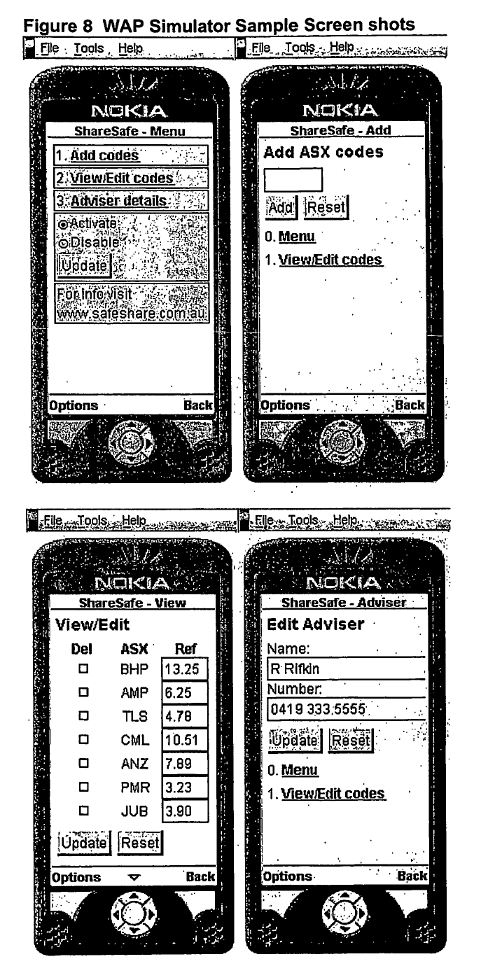

FIG. 8 shows a graphical representation of what a mobile handset would look like.

Referring to the drawings there is shown an example of an SMS mobile telephone advice. In the process of the price momentum monitoring system of the invention there is included the steps of:
i. stock code data input via mobile handset (WAP and SMS gateway) or website
ii. After ASX code is logged, the PTC Reader captures the live ASX price for the logged code (Reference Price), time and date stamps entry and reconciles customer account details in Telco network.
iii. PTC Reader immediately calculates the Price Momentum Levels (PMLs) using captured Reference Price (RP).
iv. PTC Reader immediately searches for price matches between ASX live feed and PMLs, (and not on any specific price entered by the user)
v. The RP determines the PMLs. The RP is automatically amended as the price of a stock moves out of the PML data range so as to keep it current or it can be changed by the end-user at any time manually;
vi. The fact that a PML has been price matched with a dynamic data price is communicated by an SMS/email to the end-user.

The SMS alert could read:
“Stock Advice! Stock code TLS in your portfolio has risen and triggered a key trading (LL1) level Call your adviser on 0 to discuss. End of Safeshare™ advice message”.

Each message contains the contact details of the customer adviser linked to an automatic call back function. If an end-user does not have a client adviser, a default number will be included to permit the end-user to establish new adviser account details with preferred stockbroking firms.

Once an advice for a stock code has been triggered, no further inputting of data is required for that stock code. An advice can only occur once in succession. This is made possible because an advice can only be repeated after another advice level has been triggered; i.e. SL1, SL2, SL1, SL2, SL3, SL2, etc; but never SL1, SL1, SL2, SL1, SL1, etc.

This specific advice sequencing addresses multi generation of the same advice event in a row repeatedly. This function is called Alternate Alert Generation (AAG). Therefore, the AAG function means that triggered advice levels, unlike in price based systems, do not require re entering advice data by the end-user since an advice can only be generated twice or more if a different advice level has been triggered first.

The Price Monitoring System of the invention is a way of automating the whole stock monitoring process. It is a telecommunications based application that utilises the programming of preset trading levels (called PMLs) that are calculated from a reference price captured the moment an end-user keys in an ASX code via a mobile handset or website. Price Monitoring System requires the entry of only a stock code i.e. three pushes of a mobile handset/computer keyboard key representing three letters only.

The reference price is time and date stamped and is critical in calculating a series of split price trigger levels on both the upside and downside (PMLs).

1. End user keys in a three letter code into a mobile handset or website; i.e. “TLS” through SMS network, web or WAP portal.

2. Information request sent to a secure linked database that interfaces with the ASX live data feed. The ASX price for the input code is time and date stamped. This price is called the reference price and is used to calculate all the key trend points called price momentum levels (PML).

3. SL1=−5% SL2=−10% SL3=−15% SL4=−20%
LL1=+10% LL2=+20% LL3=+30% LL4=50%
   These PML points are then used to identify price matches with the ASX live data feed

4. SMS advice or email is generated when ASX price=PML i.e. LL1 etc. Once a price match is identified, an advice is generated and sent to a mobile (SMS Advice) or to a PDA/PC (email).

When an end-user logs an ASX stock code into their mobile handset or website to be monitored, at the moment of login, the entry is time and date stamped and the price of the stock is captured. This price is called the reference price. This price is not used in the monitoring loop as in other alert or stock management systems that are price based. Instead, the reference price is used to calculate a series of price levels both up and down. These levels are called Price Momentum Levels (PMLs) and it is these key price momentum or movement levels that enable stocks to be monitored automatically with minimum manual in put or update.

This is further illustrated in FIGS. 2 and 3. The PML price levels can be changed by altering the reference price.

Changing Reference Price (RP)—this is done automatically for the average person or end-user. For example, stock A is logged in at $1. The PMLs are instantly calculated from the RP i.e. SL1=0.95, SL2=0.90, SL3=0.85, SL4=0.80;
LL1=1.10, LL2=1.20, LL3=1.30, LL4=1.50.

When the stock moves beyond each extreme level in the PML range i.e. either on the downside, SL4 or on the upside, LL4, the Reference Point is automatically reset at one of these points. i.e. at SL4 if stock has moved down, LL4 if it has moved up. In the example above, if the stock price rose to $1.85 (no advice messages would be generated because the price had moved beyond the PML advice levels), the reference price would be automatically reset at $1.85. The instant this happens, a new set of PMLs are calculated based on the new reference price i.e. SL1=1.75 etc.

Manual changing of the Reference Price (RP)—For professional traders who need to be able to monitor stocks that they wish to buy and trade, a function enabling them to manually change a stocks reference point and reset the PMLs from either their mobile handset or the website is available.

It can be seen that this embodiment utilises four integrated functions as follows:

1. Alternate Advice Generation (AAG)—

This function enables only one advice message to be generated in succession for each price movement level trigger previously calculated. If an advice message has been generated from the triggering of a specific price movement level, this same advice message can only be generated again once a new price movement level has first been triggered eg SL1, LL1, LL2, LL1, SL1, LL1 not SL1, SL1, LL1, LL1, LL1, LL2 etc This is why Safeshare™ SMS Direct™ incorporates multiple price movement levels both up and down. ie SL4, SL3, SL2, SL1 LL1, LL2, LL3, LL4. These PMLs are calculated from the stock code log in real time price.

With most stock management or alert systems, the problem of multiple alerts for the same trigger level intraday is addressed by washing each triggered alert from the system. This then requires the end-user to re input fresh data to maintain activity and status. The AAG function is novel for the Safeshare™ SMS Direct™ application and, in conjunction with the other key functions, creates a totally unique, ongoing and fully automated stock monitoring system that facilitates request (PTC Reader) and response (PTC Interpreter) actions via the SMS Gateway.

2. Reference Price Reset (RPR)—

Every time a stock code is SMS texted to Safeshare™ for monitoring, the real time price for the stock is instantly captured.

This price is called the Reference Price or log in price. Once the outer price movement levels are triggered by a price movement in that direction, i.e. SL4 and LL4, the RP is automatically reset at these price levels i.e. RP2, RP3 in the example below etc

Once the RP reset is complete i.e. RP→RP2, a new series of price movement levels are automatically calculated and set i.e. SL8, SL7, SL6, SL5/LL5, LL6, LL7, LL8 and therefore the stock monitoring continues automatically and ongoing. In the example below, RP represents the original log in price of the stock and SL4, SL3, SL2, SL1/LL1, LL2, LL3, LL4 represents the original price movement levels that were calculated and set. SL4 represents another outer price movement level in the opposite direction at which the RP can be reset should the stock price move to that level. This function enables the Safeshare™ stock monitoring system to be completely ongoing, automated and continuous. This function is applicable on both the upside and downside of the RP.

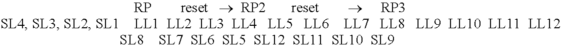

This shows how the RP is reset at different outer price movement levels and how each series of PMLs is calculated after each RP reset point.

i.e. at RP log in set, the PML series is SL4, SL3, SL2, SL1/LL1, LL2, LL3, LL4 at RP2reset at LL4, the PML series is SL8, SL7, SL6, SL5-RP2-LL5, LL6, LL7, LL8, at RP3 reset at LL8, the PML series is SL12,SL11, SL10, SL9-RP3-LL9, LL10, LL11, LL12, etc.

3. PTC Reader —

The Proprietary Trade Configurer Reader captures the login price (or Reference Price) of a logged stock and from this price, calculates the key price movement levels (PMLs). This also occurs when the RP is being reset.

The PTC Reader then searches for price match-ups between the live exchange data feed and the calculated PMLs. Once a price match-up is identified, the PTC Reader automatically generates an SMS advice message that is sent via the mobile SMS network to the end-user. In addition, the PTC Reader sets up account details and time/date stamps every stock code entry. This PTC Reader process in calculating the PMLs is central to the ability of Safeshare™ SMS Direct™ to deliver a fully automated 24 hour/7 day stock monitoring service utilising the SMS Gateway platform. Without the PML calculations, the system could not work as an SMS Gateway or web application. To better illustrate this, let us assume that the SMS Gateway is used in exactly the same way but this time, simply captures and uses just the real time log in or reference price to identify match-ups i.e. similar in concept to price based alert and portfolio management systems.

The system fails right there because without the PMLs, a match-up between log in price and the live exchange feed would occur instantly. There would be no point to this. Therefore, the creation of price movement levels provides the basis and means by which Safeshare™ SMS Direct™ can operate dynamically and automatically as a stock monitoring system.

The calculation of the PMLs from the captured log in price in conjunction with the other key operational functions enables Safeshare™ SMS Direct™ to operate as a fully automated, ongoing 24 hour/7 day stock monitoring system. As a result of this process, an end-user is only initially required to enter one data element i.e. the stock code. Most, if not all, other systems require at least two data elements to be initially entered—i.e. stock code and price or % fall or rise, volume etc. Entering multiple data elements, particularly numbers, in SMS Gateway processes becomes a real encumbrance to the end-user. In the case of Safeshare™ SMS Direct™, no numbers are required; only a letter code.

4. PTC Interpreter—

The Proprietary Trade Configurer Interpreter reads and interprets the SMS advice instructions sent by the end-user and actions these instructions. This is better illustrated in FIG. 4 the “Safeshare™ SMS Direct™ Menu”.

In a particularly preferred, fully automated, embodiment the monitoring process is simplified by using just two RVLs. These RVLs are set by the user with any desired “tolerance level” or proportional variation from the RI. Once the LDV matches one of the RVLs, that RVL becomes the new RI and a new pair of RVLs is calculated and set using the same tolerance level.

The desired variable (e.g. a stock) is entered into the PTC Interpreter, together with the desired tolerance. For example, this can be done by nominating ABCt15, which means that stock ABC will be monitored with a tolerance level of 15%. The tolerance can be set at any limit between 0 and 999, including decimals.

By this means each variable in a user's portfolio can be monitored at individually tailored tolerances. However, if a user wishes to set the whole watchlist at a certain level, he sends just the letter “t” followed by the desired tolerance level. For example, for a tolerance of 13% the message t13 would be sent to the PTC Interpreter. This embodiment is illustrated schematically in FIG. 5.

ANNEX: Software Programming Requirements

The psuedocode to guide a software programmer in the collation of a suitable program to perform the invention is as follows:

Overview

Safeshare™ monitoring consists of a database containing information about a subscriber such as their mobile phone number, email address, advisors phone number and personal message text they would like to receive via SMS or email. Subscribers select stocks that they wish to have monitored on their behalf. A PTC Reader application monitors a master list of stocks for price variations and advises the relevant subscribers with an SMS and/or email custom advice should a stock pass a key price level.

User Interfaces

The user may register, add/delete and enter preferences via the SMS gateway, web or WAP portal browser. The mobile phone (SMS/WAP) interface uses the same database as the website so the user may switch between using their phone and an internet browser to administer their Safeshare™ account.

In the most basic circumstance, the user would SMS or browse on their phone to the Safeshare™ WAP site and enter one or more 3 letter share codes and this would be all that is required for them to commence receiving price movement advices. Additionally the user could then choose their advice preference such as email, SMS, both or temporarily suspend all advice messages.

[image]

tblUser

Users mobile phone number is primary key for this table and stores other associated User information such as Advisor's phone number and the format of the message they wish to receive.

tblPicks

Stores snapshot price of a nominated ASX code together with calculated PML levels and Advice Messages.

If an advice message is sent out then it is flagged to eliminate another advice message of the same level getting sent unless another price level is reached in the meantime.

This table will not be completely normalized so as to optimize speed when the PTC Reader scans this table for advice candidates.

tblPML

Defines each advice (PML) level and the default advice message that corresponds to this level.

When a User defines a stock they will get the default advice message assigned to their selection initially however they may be able to customise this message themselves (in a later version).

tblStocks

As each new stock code is added by any user it is also added to this master table of stocks under watch by the PTC Reader.

This table will grow and shrink dynamically as stocks are added and deleted to peoples watch lists.

To maximise performance only these stocks will be analysed via the live ASX feed eliminating redundant updating of stock prices from the ASX when no watch lists require this data.

A flag is stored to indicate if a price remains unchanged since the last update. Should this be the case then the PTC Reader need not account for this code in its next analysis.

PTCReader

An application daemon that monitors the stocks table for any price movements. When a price movement is detected the application searches for details of the user who has that stock on their watch list and constructs the relevant advice and sends it.

Pseudocode

Select all stocks that have a price change since last cycle

With each changed stock
Select all users who have this stock in their watch list
With each user
   Determine if price change for stock crosses a key indicator level
   Construct and send appropriate alert
Next user

Next stock

Next cycle

Advice Messages

Translations

The message will have embedded key words that will be dynamically translated at runtime such as.

| | |
|---|---|
| <adviser_no> | Advisor's telephone number. |
| <asx_code> | ASX code this advice message relates to. |
| <watch_name> | Watch name this stock is assigned under. |
| <advice_level> | The key trading advice level. |

For example the advice for SL1 could be:

Safeshare ™ Advice !
“Stock code <asx_code> in your <watch_name> portfolio has fallen and
triggered a key trading (<advice_level>) level. Pls call your adviser on
<advisor_no> to discuss action”.
End of ShareSafe message advice

Safeshare™ Advice!
“Stock code TLS in your CORE portfolio has fallen and triggered a key trading (SL1) level
Pls call your adviser on 0409090780 to discuss action”.
End of Safeshare™ message advice

Technology & Tools

Current prototype.

Minimum System Requirements
Operating System Win32 (Windows)™
IIS—Internet Information Server—to host ASP/WAP application
SQL Server

Recommended System Requirements
Windows 2000™ Server with IIS
SQL 2000™

It should be understood that the above description is by illustration only and is not limiting on the invention. Clearly persons skilled in the art would understand variations to the above without any inventive input and such variations are included within the scope of this invention.

1. A variable momentum monitoring system including the steps of:
receiving from a user an identification of a required variable data input;
obtaining the current live static value (LSV) of the identified required data input from a dynamic live data-stream and determining it as a base reference input (RI);
calculating at least two sets of one or more incremental reference variable levels (RVLs) using the determined RI, one of the sets having values less than the RI and the other set having values greater than the RI;
searching dynamic live data values (LDV) of the identified required data and comparing with the reference variable levels (RVLs);
communicating to the user when the current live value of the identified required data matches with any of the reference variable levels (RVLs);
defining the outer reference variable level points as reset points, such that when the current live value of the identified required data matches with one of the outer reference variable levels the RI is automatically reset and new reference variable levels (RVLs) are automatically calculated without the need for end-user input.

2. A system according to claim 1 in which when a LDV matches a RVL, an advice message is generated and communicated to the user.

3. A system according to claim 2 in which the LSV of a required data input (where LSV=RI) is captured and used to calculate the RVLs.

4. A system according to claim 3 in which the RVLs are calculated as predetermined variations from the captured RI.

5. A system according to claim 4 which permits the end-user to reset or reprogram the RI and/or the RVLs.

6. A system according to claim 5 in which the momentum is communicated in time display format or is received and computed by the receiver of the user into a time display format based on signals of matches to the reference input (RI) or one or more of the reference variable levels (RVLs).

7. A system according to claim 6 in which the identification of the required variable data input by the user may is by digital mobile telephone (utilising WAP and SMS gateway), internet, intranet or general telecommunications network (telephone).

8. A system according to claim 7 in which the communication of any match between the live data values and the calculated RVLs to the end-user is by SMS.

9. A system according to claim 2 which enables only one advice message to be generated in succession for each RVL trigger previously calculated such that if an advice message has been generated from the triggering of a specific RVL this same advice message can only be generated again once another RVL has first been triggered

10. A variable momentum monitoring system including the steps of:
receiving from a user an identification of a required variable data input and an identification of a required proportional variation of the variable;
obtaining the current live static value (LSV) of the identified required data input from a live data-stream and determining it as a base reference input (RI);
calculating two sets of one each of incremental reference variable levels (RVLs) using the determined RI and the user's identified required proportional variation, one of the sets having a value proportionally less than the RI and the other set having a value proportionally greater than the RI;
searching dynamic live data values (LDV) of the identified required data and comparing with the RVLs;
communicating to the user when the current live value of the identified required data matches with either of the RVLs; and
resetting the RI to the value of the matched RVL and recalculating the two RVLs using the reset RI and the user's identified required proportional variation.

11. A system according to claim 10 in which the proportional variation can be set at any value between 0-999%.

12. An automatic telecommunications based price momentum monitoring system which comprises stock exchange (SX) stock code data input by a user via mobile handset or website in which:
an SX code is logged;
a proprietary trading combination (PTC) reader captures the live SX price for the logged SX code as a reference price (RP) and time and date stamps the entry and reconciles customer account details in a telecommunications provider's network;
the PTC reader immediately calculates two sets of price momentum levels (PMLs) using the captured RP of each logged SX code, one set above the RP and the other set below the RP;
the system searches for price matches between SX live feed and PMLs and when a match is detected the system sends a telecommunication to the user; and
the RP is automatically reset as the price of a stock moves out of the PML alert range (i.e. beyond either the upper PML or the lower PML) so as to enable the system to be automatic and ongoing.

13. A system according to claim 12 in which the reset function can be facilitated by the end-user at any time manually.
